(19) United States
(12) Patent Application Publication
(10) Pub. No.: US 2024/0295476 A1
(43) Pub. Date: Sep. 5, 2024

(54) METHOD FOR CHARACTERIZING A MECHANICAL COMPONENT

(71) Applicants: CENTRE NATIONAL DE LA RECHERCHE SCIENTIFIQUE, Paris (FR); ECOLE NORMALE SUPERIEURE PARIS-SACLAY, Gif-Sur-Yvette (FR); SAFRAN, Paris (FR); SAFRAN AIRCRAFT ENGINES, Paris (FR)

(72) Inventors: Julien Paul SCHNEIDER-DIE-GROSS, Moissy-Cramayel (FR); Arturo MENDOZA QUISPE, Moissy-Cramayel (FR); Stéphane ROUX, Paris (FR)

(73) Assignees: CENTRE NATIONAL DE LA RECHERCHE SCIENTIFIQUE, Paris (FR); ECOLE NORMALE SUPERIEURE PARIS- SACLAY, Gif-Sur-Yvette (FR); SAFRAN, Paris (FR); SAFRAN AIRCRAFT ENGINES, Paris (FR)

(21) Appl. No.: 18/573,850

(22) PCT Filed: Jun. 16, 2022
(86) PCT No.: PCT/FR2022/051174

§ 371 Date: Dec. 22, 2023

(30) Foreign Application Priority Data
Jun. 23, 2021 (FR) FR2106703

(51) Int. Cl. G01N 3/02; G06N 5/022

(52) U.S. Cl. CPC G01N 3/02; G06N 5/022

(57) ABSTRACT

A method for characterizing a mechanical part making it possible to evaluate the residual stresses in the part, as well as a method for constructing a predictive model and a non-destructive testing method making it possible to easily test such a part, the characterizing method including the following steps: measuring geometrical information of the part in a first state, physically transforming the part between the first state and a second state, measuring geometrical information of the part in its second state, determining the displacement field between the first state and the second state of the part by a digital image correlation method and obtaining the deformation field between the first state and the second state of the part, determining the stress field in the second state of the part by a finite element simulation method.

### TECHNICAL FIELD

This summary relates to a method or characterizing a mechanical part making it possible to evaluate residual stresses in the part, as well as a method for constructing a predictive model and a non-destructive testing method making it possible to easily test such a part.

Such methods can in particular be used in the aeronautical field, and especially for parts with mechanical behavior that is difficult to predict, such as parts exhibiting behavior other than isotropic, for example 3D-woven composite material parts.

### PRIOR ART

The design of certain aeronautical parts is particularly complicated due to the undesirable effects of the residual stresses, which tend to deform the parts and make them deviate from their expected geometry. This is particularly the case of fan blades made of 3D-woven composite material constructed by the resin transfer molding method, in which the parts undergo a slight deformation when they are taken out of their molds.

If it is not possible to correctly characterize these residual stresses and the associated deformations, the design of such parts requires many iterations over the course of which one observes the deviation from the geometry desired for the part n and the design n+1 is adapted in an attempt to compensate for this deviation, which still usually results in a geometrical deviation, but one less significant than the previous one: the iterations are then continued until the deviation from the desired geometry is deemed small enough.

This obviously involves a considerable waste of time, waste of materials, and the significant cost that such iterations incur (such as, for example, the construction of several molds).

This lack of characterization leads to other difficulties, particularly in the field of non-destructive testing. Specifically, to date, the metrological inspection of these parts only makes it possible to compare the geometry with an acceptable target incorporating a predetermined tolerance without any information about the presence of residual stresses, and therefore about the health of the material.

Specifically, to date, the known methods for checking the presence of such residual stresses require machining of the part, by drilling holes for example, and observation of the resulting deformations. However, these methods are limited to simple geometries and, most importantly, lead to the destruction of the part: it is therefore not possible to routinely use them in production.

A genuine need therefore exists for a method for characterizing a mechanical part, along with a method for constructing a predictive model and a method of non-destructive testing, which are free, at least in part, of the drawbacks inherent to the aforementioned known methods.

### SUMMARY OF THE INVENTION

This summary relates to a method for characterizing a mechanical part, comprising the following steps:
measuring geometrical information of the part in a first state,
physically transforming the part between the first state and a second state,
measuring geometrical information of the part in its second state,
determining the displacement field between the first state and the second state of the part by a digital image correlation method and obtaining the deformation field between the first state and the second state of the part,
determining the stress field in the second state of the part by a finite element simulation method.

One such digital image correlation method is a method of non-rigid registration between image pairs which is known in the field of experimental mechanics in order to compute the deformation of a sample when an external effort or a thermal stress is applied to it. The method is based on the assumption of the conservation of gray levels in the region of interest under consideration. Thus, for a so-called reference image f(x) and a test image g(x), the registration in question consists in finding the transformation T that makes it possible to correct the test image (g∘T)(x) in order to minimize the norm L₂ of their differences (also known as the residual field), η(x)=(g∘T)(x)−f(x).

This minimization is often done via a Gauss-Newton iterative solving method. To better constrain this problem, the transformation T can be limited to a reduced base composed by known form functions, for example the form functions of the Finite Element (EF) method.

Thus, the transformation T applied to the test image g(x) can be expressed in the form (g∘T)(x)=g(x+u(x)) where u(x) corresponds to the desired displacement field and is defined by: u(x)=Σᵢ uᵢ φᵢ(x) with φᵢ(x) the known form functions and uᵢ the associated amplitudes to be found via the optimization. Note that the displacement field may concern either the surface of the part (SC) or the entire volume of the part (VIC).

Thus, using such a digital image correlation method comparing the geometrical information of the part before and after its transformation, it is possible to determine the displacement field experienced by the part during the transformation and hence its deformation field. In the case of volume measurements (VIC), this deformation field can then be injected into a finite element simulation to obtain the stress field in the second state of the part. In the case of surface measurements (SC), it is also necessary to provide a 3D microstructure model (for example, a computer-assisted design model), position the model with respect to the measured surface, provide a model of its mechanical behavior and use the surface displacement field to perform a finite element simulation making it possible to estimate the deformations and stresses throughout the whole volume.

Thus, using this method, it is possible to obtain information about the residual stresses, and therefore about the material health, of the part in its second state. In particular, this method does not require the use of simplifying assumptions regarding the geometry of the part.

Knowing this stress field, and no longer just the final geometry of the part, then makes it possible to facilitate and speed up the design of a new part; for example, the successive iterations of mold design are no longer done blind. In this way substantial savings are made during design.

Moreover, such a method makes it possible to assess the material health of a part, without having to resort to alteration of the part: it is therefore possible to use such a method on production parts, where applicable routinely, in order to test their acceptability, both on the geometrical and structural levels.

Finally, this method has the advantage of requiring as sole input the geometric information of the part before and after the transformation, which can be done simply and inexpensively using existing measuring means.

In certain embodiments, the physical transforming of the part is mechanical or thermal, or even chemical loading (for example: crosslinking of a polymer, solvent loss), and/or machining.

In certain embodiments, the geometrical information of the part includes at least the surface geometry of the part. The digital image correlation used, in this mode, will be surface digital image correlation, also known as stereo-correlation SC.

In certain embodiments, the geometrical information of the part includes the volume geometry of the part. A greater amount of information is thus available, which allows for volume digital image correlation and therefore increases the reliability of the method. The digital image correlation used will be volume image correlation VIC.

In certain embodiments, the geometrical information of the part includes the internal structure of the part. This is particularly beneficial when the part has a heterogenous internal structure, for example woven or grainy. An even greater amount of information is thus available, which facilitates the digital image correlation and therefore increases the reliability of the method. In this way it is also possible to more easily track the displacement of certain internal structures of interest.

In certain embodiments, the measurement of the geometrical information of the part is done non-destructively, and preferably without contact with the part.

In certain embodiments, the measuring of the geometrical information of the part is done by a three-dimensional measuring machine (TMM), a fringe projection system (SPJ) and/or a tomograph (CT).

In certain embodiments, the measuring of the geometrical information of the part is done at least by a tomograph (CT). This measuring means makes it possible to obtain measurements of surface and volume at once. In particular, it is used to obtain volume information, and particularly images of the internal structure of the part, and no longer just surface ones, which makes it possible to provide a much more significant amount of information.

In certain embodiments, the digital image correlation method is a surface method, for example of stereo-correlation type.

In certain embodiments, the digital image correlation method is a three-dimensional method of volume image correlation type.

In certain embodiments, the characterizing method comprises a step of providing an equation of behavior of the part and the parameters of this equation. This model describes the mechanical behavior of the part and is used to compute its stress field as a function of its deformation field.

In certain embodiments, the characterizing method comprises a step of determining a behavioral model of the part and the parameters of this behavioral model. When a reliable behavioral model is not yet known for the part, and can therefore not be provided a priori, this step makes it possible to determine one.

In certain embodiments, the step of determining the behavioral model of the part employs an identification method of FEMU (Finite Element Model Updating) type. Using this method, finite element simulations of the test are done iteratively to find the constitutive parameters allowing for the best match between the computed and actual measurements.

In certain embodiments, the step of determining the behavioral model of the part employs a method of CEGM (Constitutive Equation Gap Method) type. Using this method, one seeks to minimize a functional of the CEG (Constitutive Equation Gap), which makes it possible to obtain the identified values of the constitutive parameters.

In certain embodiments, the step of determining the behavioral model of the part employs a method of VFM (Virtual Fields Method) type. This method is based on the principle of applied virtual work with carefully-chosen virtual fields.

In certain embodiments, the step of determining the behavioral model of the part employs a method of EGM (Equilibrium Gap Method) type. This method is based on the discretization of the equations of equilibrium and the minimization of the equilibrium gap.

The methods detailed previously can thus be used to find the constitutive parameters allowing the best match between the displacements predicted by the computation and the measurements taken beforehand by image correlation. More precise explanations concerning these methods can be found in the literature, and particularly in the following document, which is included by reference: “S. Avril, M. Bonnet, A. S. Bretelle, M. Grédiac, F. Hild, P. Ienny, F. Latourte, D. Lemosse, S. Pagano, E. Pagnacco and F. Pierron, “Overview of identification methods of mechanical parameters based on full-field measurements,” Experimental Mechanics, pp. 381-402, 2008.”.

In certain embodiments, the step of determining the model of the behavior of the part is incorporated into the digital image correlation method. Thus, the measuring and identifying steps are carried out in a single analysis. In such an integrated method the desired transformation T is parameterized by the defined behavioral equation, the material parameters to be identified, and the boundary conditions in question. Thus any uncertainty related to measurement is directly considered in the overall optimization procedure.

The incorporated procedure then comprises the following steps:
1) define a set of initial parameters,
2) perform a finite-element simulation of the transformation with the set of parameters,
3) measure the displacement field expressed with this set of parameters,
4) estimate the estimation error by comparing the simulation results with the measuring results,
5) compute the required correction to be made to the parameters given the obtained error,
6) update the parameters according to the estimated correction,
7) repeat steps 2 to 6 to convergence.

In certain embodiments, the behavioral model of the part and the parameters of this behavioral model are established based on results obtained by applying the characterizing method to a part of smaller scale sharing at least some structural features with the part. For example, tests can first be conducted on test pieces, which thus have simplified geometries, in order to determine a suitable behavioral model for these test pieces, then this model, optionally adjusted, can be reused for the part of larger size, either to constitute the behavioral model of the part, or to constitute the starting point of the step of determining the behavioral model of the part. By proceeding in this way, one can use the knowledge gained at the smaller scale to speed up the convergence of the method at the larger scale and/or to improve the reliability of the method at the larger scale.

In certain embodiments, the part is made of a material exhibiting anisotropic mechanical behavior, particularly made of 3D-woven composite material. The behavior of these materials is difficult to model and is highly dependent on the geometry of the part and on the structure of the weave. In addition, such materials have a rich structure, easily identifiable, which facilitates the digital image correlation.

In certain embodiments, the characterizing method comprises a prior step of placing visual reference markers on the surface of the part. This can in particular be a surface speckle. These markers are used to facilitate the digital image correlation, particularly when the structure of the part does not offer enough natural reference markers.

In certain embodiments, the part is a test piece. The transformation can then be of any type, for example mechanical or thermal loading. Applying the characterizing method to such a test piece makes it possible to determine a behavioral model for a simple case. The results obtained can then be made use of for the characterization of a part of larger size.

In certain embodiments, the part is an experimental part. It can then be a part having a size larger than a simple test piece, having the geometry of the final part or else an intermediate geometry, more complex than a test piece but simplified by comparison with the actual geometrical information. Such an experimental part can undergo experimental transformations, apart from the true production process, or else production transformations, forming part of the true production process. These transformations can in particular be heat treatment or machining.

In certain embodiments, the part is a production part. It can be the subject of this method in its final state, or else in an intermediate state of the production process. The transformations undergone are then production transformations, forming part of the true production process.

In certain embodiments, the first state is the state of the part on leaving the mold and the second state is the state of the part after all the machining planned for this part.

In certain embodiments, the first state is the state of the part after all the machining planned for this part and the second state is the state of the final part after all the finishing planned for this part.

In certain embodiments, the part is a turbomachine blade, preferably a fan blade.

This summary also relates to a method for constructing a predictive model,
comprising the following steps:
supplying a large number of parts of the same kind,
applying the characterizing method as claimed in any of the preceding embodiments to each of these parts,
performing a statistical analysis of the obtained results and defining geometry typologies attached to certain structural peculiarities of the part, and
constructing a predictive model configured to predict the existence of structural peculiarities in the part based on its geometrical information.

Using such a method, it is possible to characterize a large number of parts of the same kind, i.e. corresponding to the same part reference number, so identical to the nearest variation, in order to identify, by considering parts having analogous geometrical information as alike, or at least as having common geometrical peculiarities, families of parts having in common one or more structural peculiarities, i.e. structural peculiarities not directly observable, for example an area having high residual stresses.

The statistical analysis of such a large number of parts makes it possible to identify certain structural peculiarities which might not have drawn attention on the basis of only a few samples, and to decide whether or not these structural peculiarities must be considered as anomalies.

Hence, when a new part is characterized, it is possible to predict, by attempting to liken this new part to the typologies thus referenced, the structural peculiarities of the new part.

In certain embodiments, at least 3 parts of the same kind, and preferably at least 50 parts of the same kind, are supplied and characterized.

In certain embodiments, at least some structural peculiarities of the part are particular deformations deviating from the theoretical internal structure of the part. These particular deformations may be associated with a state of unacceptable stresses; others may be referenced but nonetheless be deemed acceptable.

In certain embodiments, the method for constructing the predictive model comprises a training step on the selected parts resulting in the definition and recognition of the deformation typologies by a learning model, for example a neural network.

In certain embodiments, the constructing method comprises a step of defining and recognizing elementary modes, each corresponding to a given structural peculiarity. In this way, it is possible to describe any new deformation or stress field observed in the form of a combination of these elementary modes.

In certain embodiments, the method of constructing the predictive model comprises a step of defining non-destructive testing criteria making it possible to conclude in the acceptability or otherwise of the part.

This summary also relates to a non-destructive testing method, comprising the following steps:
measuring geometrical information of a part to be tested,
providing geometrical information of the part to be tested to a predictive model constructed using a method as claimed in any of the preceding embodiments and determining the existence or otherwise of structural peculiarities in the part.

In certain embodiments, the non-destructive testing method comprises a step of determining the displacement or deformation field of the part to be tested. This displacement field is determined between a first state corresponding to the state of the part on leaving the mold and a second state corresponding to the final state of the part. The geometrical information in the first state can be remeasured for each part or else reference geometrical information can be commonly used for all the parts of a given kind.

In certain embodiments, the non-destructive testing method comprises a step of determining the stress field in the part to be tested.

In certain embodiments, the non-destructive testing method comprises a step of deciding on the acceptability of the part.

In certain embodiments, the measurement of the geometrical information of the part to be tested is done solely using a tomograph or by fusing the measurements of a tomograph with that of a three-dimensional measuring machine.

This summary also relates to a computer program comprising instructions for executing the steps of the characterizing method as claimed in any of the preceding embodiments, of the method for constructing a predictive model as claimed in any of the preceding embodiments, or of the non-destructive testing method as claimed in any of the preceding embodiments, when the program is executed by a computer.

This summary also relates to a recording medium comprising a computer program as claimed in any of the preceding embodiments.

The term “3D weave” or “three-dimensional weave” should be understood to mean a weaving technique in which warp yarns circulate within a matrix of weft yarns in such a way as to form a three-dimensional web of yarns in a three-dimensional interlock: all the yarn layers of such a fibrous structure are then woven during one and the same weaving step in a loom.

The aforementioned features and advantages, along with others, will become apparent on reading the following detailed description, of exemplary embodiments of the method for characterizing a mechanical part, of the method for constructing a predictive model and of the non-destructive testing method for which provision is made. This detailed description references the appended drawings.

### BRIEF DESCRIPTION OF THE DRAWINGS

The appended drawings are schematic and aim first and foremost to illustrate the principles of the summary.

In these drawings, from one figure to the next, identical elements (or element parts) are marked by the same reference signs.

FIG. 1 schematically represents a first characterizing method applied to a test piece.

FIG. 2 schematically represents a second characterizing method applied to a part.

FIG. 3 schematically represents a method for constructing a predictive model.

FIG. 4A illustrates a first example of a structural peculiarity.

FIG. 4B illustrates a second example of a structural peculiarity.

### DESCRIPTION OF THE EMBODIMENTS

To make the summary more practical, exemplary embodiments of the method for characterizing a mechanical part, of the method for constructing a predictive module and of the non-destructive testing method for which provision is made are described in detail hereinafter, with reference to the appended drawings. The reader is reminded that the invention is not limited to these examples.

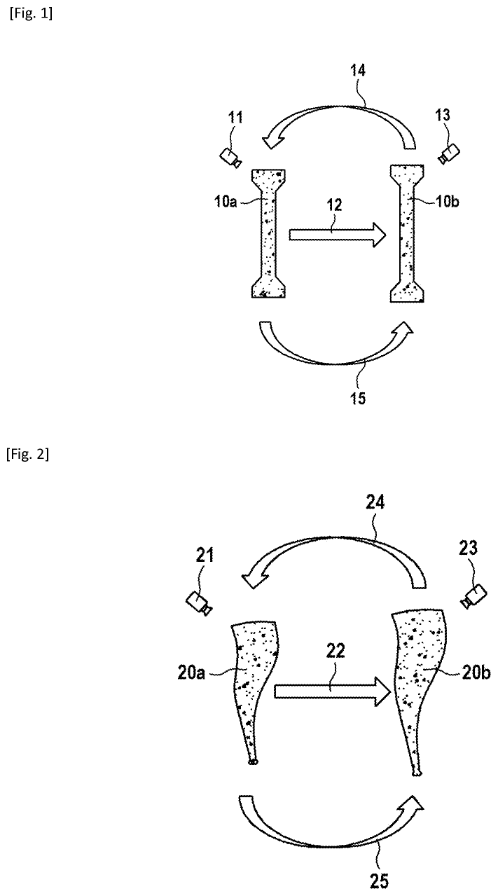

FIG. 1 schematically represents a first example of a characterizing method. This first characterizing method is applicable to a test piece. This test piece is made of 3D-woven composite material based on a resin-coated fiber preform using an injection of RTM (Resin Transfer Molding) type.

The test piece is shown on the left in a first state 10a. It then undergoes a first measuring step 11 making it possible to obtain geometrical information about the first state 10a of the test piece.

This measuring step can be performed by a three-dimensional measuring machine (TMM). Such a three-dimensional measuring machine comprises a plurality of feelers travelling over the surface of the part, usually in predetermined planes, This results in the determination of several contours of the part.

This measuring step can also be done by a fringe protection system (SPJ). Such a fringe projection system comprises a fringe projection device on the surface of the part and a camera which, recognizing the projected fringes, is capable of extracting a cloud of points representing the elevation of the surface of the part.

This measuring step can also be carried out by a tomograph (CT). Such a tomograph gives access to the volume geometry of the whole part, and also to its internal structure.

The test piece then undergoes transformation 12 bringing it into a second state 10b. This transformation 12 can in particular be mechanical and/or thermal loading according to a conventional test protocol in the field.

Once this transformation 12 has been carried out, it undergoes a second measuring step 13 making it possible to obtain geometrical information about the second state 10b of the test piece. The measuring device or devices used are similar to those used during the first measuring step in order to possess geometrical information comparable between the first state 10a and the second state 10b.

The geometrical information of the first state 10a and of the second state 10b are available in an image format as soon as the measurement is taken or are, optionally, converted into such an image format. The geometrical information of the first state 10a and of the second state 10b are then provided to an integrated digital image comparison algorithm 14 in order to determine, on the one hand, the displacement field between the first state 10a and the second state 10b of the test specimen and, on the other, the constitutive parameters of the behavioral model of the test piece. The obtainment of the displacement field also results in the obtainment of the deformation field between the first state 10a and the second state 10b of the test piece.

Once the deformation field and the constitutive parameters of the behavioral model have been determined, it is possible to conduct a finite element simulation step 15 sing the behavioral model thus determined and by applying the measured displacement field to the first state 10a of the test piece. This step 15 then results in the obtainment of the stress field in the second state 10b of the test piece.

FIG. 2 schematically represents a second example of a characterizing method, this time applied to a part. This part is also made of 3D-woven composite material based on a resin-coated fiber preform using an injection process of RTM (Resin Transfer Molding) type. It does however have more complex geometrical information than a simple test piece: it can in particular be a production part or else an experimental part having the same geometrical information as a production part or envisioned for production. It can in particular be a fan blade for a turbojet engine.

The part is shown on the left in a first state 20a corresponding to its state on leaving the mold. The arrow 22 shows the set of transformations undergone by the part after it leaves the mold, and in particular heat treatments and/or machining, these transformations 22 resulting in the second state 20b of the part.

The characterizing method can then occur in a similar way to the case of the test piece above: measuring steps 21, 23 are carried out over the first state 20a and the second state 20b of the part in order to obtain its geometrical information before and after the transformations 22.

The geometrical information of the first state 20a and of the second state 20b are thus provided to an integrated digital image comparison algorithm 24 in order to determine the displacement and deformation fields between the first state 20a and the second state 20b along with the constitutive parameters of the behavioral model of the part.

In this regard, it should be noted that the information obtained during the method of characterizing the test piece on the subject of the behavioral model of the test piece can be used in order to facilitate the determination of the parameters of the behavioral model of the part.

The stress field in the second state 20a of the part can then be obtained using a finite element simulation step 25.

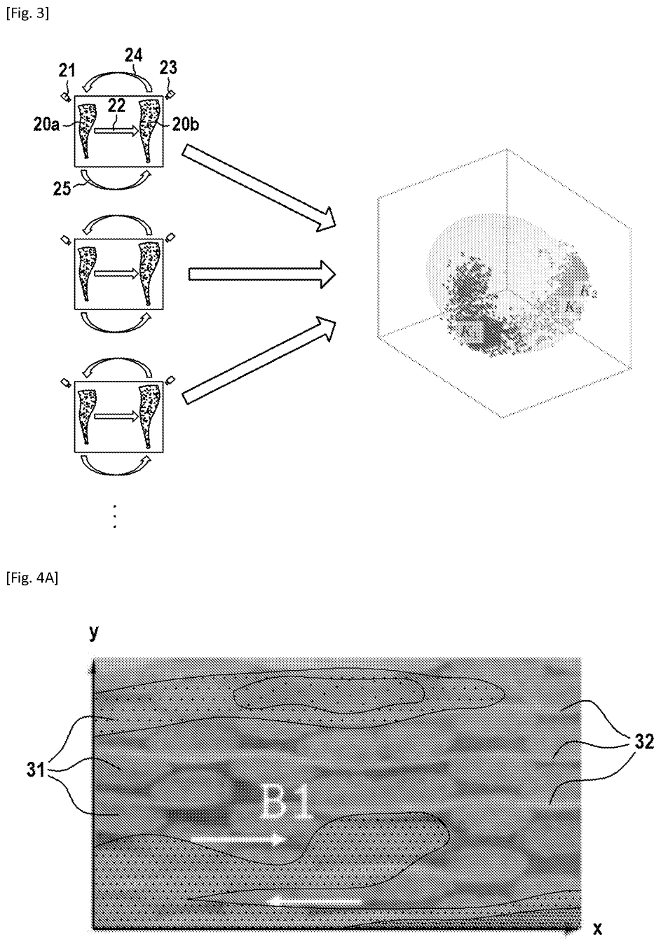

FIG. 3 now illustrates an example of a method for constructing a predictive model. The aim of this method is the construction of a predictive model for a given part model making it possible, using a simple measurement of the geometrical information of a given part, to predict the existence of any structural peculiarities of the part, in particular residual deformations and/or stresses which can constitute defects.

The method for constructing a predictive model first of all requires the characterization of several parts of the reference number under consideration, for example at least 3 parts if the manufacturing method is robust and generates little dispersion or else, for example, at least 50 parts if the manufacturing method generates more dispersion, using a characterizing method as described above.

The stress fields obtained for all these parts are analyzed and compared in order to identify structural peculiarities common to several parts: this can in particular be accumulations of stresses in certain areas of the part. A name or a reference number is then given to each of these structural peculiarities.

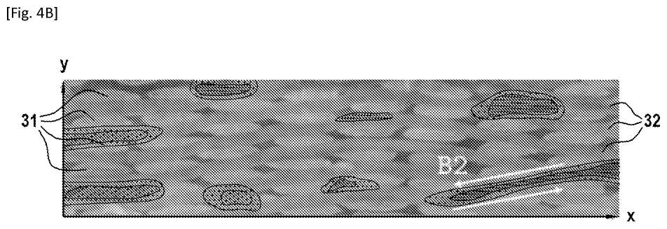

FIGS. 4A and 4B each illustrate an example of a structural peculiarity which can appear in a part of 3D-woven fan blade type. In these figures, corresponding to tomography views of the samples, the structure of the fiber reinforcement is visible with interlocked warp yarns 31 and weft yarns 32. The high deformation areas are shown in an overlay using ranges of points, the deformations being greater when the density of points is greater.

FIG. 4A illustrates a first example of a structural peculiarity: it is a shear area identified by the reference B1. FIG. 4B illustrates a second example of a structural peculiarity: it is another shear area identified by the reference B2.

A database is then constructed associating the geometrical information of each part with the structural peculiarities identified in the part in question. This results in the definition of part typologies K1, K2, K3 as a function of the structural peculiarities that they comprise.

This database can then be used to train a predictive model in order to train the latter to predict the presence of one or more structural peculiarities, thus referenced on the basis of the geometrical information of a new studied part.

In particular, this training step may comprise a step of defining and recognizing elementary modes, each corresponding to a given structural peculiarity. The mode thus learned then constitutes a predictive model capable of returning a probability of presence for each of the referenced structural characteristics.

Moreover, the study of these different structural peculiarities, and their statistical distributions among the studied parts, makes it possible to define non-destructive testing criteria making it possible to conclude in the acceptability or otherwise of a part as a function of the structural peculiarities present in the part. In particular, certain structural peculiarities will be judged as unacceptable on their own, others can be tolerated unless they are present at the same time as other predetermined structural peculiarities.

Hence, it is possible to conduct a method of non-destructive testing of a part by measuring its geometrical information and by submitting it to the predictive model thus constructed. The predictive model can then determine whether or not structural peculiarities are present in the part, and which ones, and deduce therefrom whether or not the part is acceptable or must on the contrary be discarded.

Although this invention has been described with reference to specific exemplary embodiments, it is obvious that modifications and changes can be made to these examples without departing from the general scope of the invention as defined by the claims. In particular, individual features of the different embodiments illustrated/mentioned can be combined in additional embodiments. Consequently, the description and drawings must be considered in an illustrative sense rather than a restrictive one.

It is also obvious that all the features described with reference to a method are transposable, alone or in combination, to a device, and conversely, all the features described with reference to a device are transposable, alone or in combination, to a method.

1. A method for characterizing a mechanical part, comprising the following steps:
measuring geometrical information of the part in a first state,
physically transforming the part between the first state and a second state,
measuring geometrical information of the part in its second state,
determining the displacement field between the first state and the second state of the part by a digital image correlation method and obtaining the deformation field between the first state and the second state of the part,
determining the stress field in the second state of the part by a finite element simulation method.

2. The characterizing method as claimed in claim 1, wherein the physical transforming of the part is mechanical loading, thermal loading and/or machining.

3. The characterizing method as claimed in claim 1, wherein the geometrical information of the part includes the surface geometry and/or the volume geometry of the part.

4. The characterizing method as claimed in claim 1, wherein the geometrical information of the part includes the internal structure of the part.

5. The characterizing method as claimed in claim 1, wherein the measuring of the geometrical information of the part is done by a three-dimensional measuring machine, a fringe projection system and/or a tomograph.

6. The characterizing method as claimed in claim 1, wherein the digital image correlation method is a three-dimensional method of volume image correlation type or a two-dimensional method of stereo-correlation type.

7. The characterizing method as claimed in claim 1, comprising a step of determining a behavioral model of the part and the parameters of this behavioral model, and wherein
the step of determining the behavioral model of the part employs an identification method of FEMU (Finite Element Model Updating) type, of CEGM (Constitutive Equation Gap Method) type, of VFM (Virtual Fields Method) type or of EGM (Equilibrium Gap Method) type.

8. The characterizing method as claimed in claim 1, wherein the behavioral model of the part and the parameters of this behavioral model are established based on results obtained by applying the method to a part of smaller scale sharing at least some structural features with the part.

9. The characterizing method as claimed in claim 1, wherein the part is made of a material exhibiting anisotropic mechanical behavior, particularly made of 3D-woven composite material.

10. The characterizing method as claimed in claim 1, wherein the part is a test piece, an experimental part or a production part.

11. The characterizing method as claimed in claim 1, wherein the part is a turbomachine part, particularly a turbomachine blade, preferably a fan blade.

12. A method for constructing a predictive model, comprising the following steps:
supplying a large number of parts of the same kind,
applying the characterizing method as claimed in claim 1 to each of these parts,
performing a statistical analysis of the obtained results and defining geometry typologies attached to certain structural peculiarities of the part, and
constructing a predictive model configured to predict the existence of structural peculiarities in the part based on its geometrical information.

13. The method as claimed in claim 12, comprising a step of training a learning model resulting in the definition and recognition of the geometry typologies by a learning model.

14. The method as claimed in claim 12, comprising a step of defining and recognizing elementary models each corresponding to a given structural peculiarity.

15. A non-destructive testing method, comprising the following steps:
measuring geometrical information of a part to be tested,
providing geometrical information of the part to be tested to a predictive model constructed using a method as claimed in claim 12, and determining the existence or otherwise of structural peculiarities in the part.
